(19) United States
(12) Patent Application Publication
(10) Pub. No.: US 2002/0016932 A1
(43) Pub. Date: Feb. 7, 2002

(54) Semiconductor integrated circuit and semiconductor apparatus system

(75) Inventor: Natsuki Kushiyama, Kawasaki-shi (JP)

Correspondence Address: HOGAN & HARTSON L.L.P., 500 S. GRAND AVENUE, SUITE 1900, LOS ANGELES, CA, 90071-2611, US

(73) Assignee: KABUSHIKI KAISHA TOSHIBA

(21) Appl. No.: 09/887,875

(22) Filed: Jun. 25, 2001

(30) Foreign Application Priority Data
Jun. 23, 2000 (JP) 2000-188857

(51) Int. Cl. G06F 1/26; G06F 1/28; G06F 1/30

(52) U.S. Cl. 713/300

(57) ABSTRACT

A semiconductor integrated circuit includes an input circuit which is provided with a reference potential conversion circuit. The reference potential conversion circuit is supplied with an external reference potential REF and outputs an internal reference potential VREFint differing from the external reference potential. The input circuit is supplied with an output potential VREFint from the reference potential conversion circuit as a reference potential REF. A data signal is also inputted to the input circuit. The input data signal is compared to the reference potential REF for generating a determination result. These operations improve the setup and hold times and enhance the voltage margin at the data acquisition time.

### CROSS-REFERENCE TO RELATED APPLICATIONS

This application is based upon and claims the benefit of priority from the prior Japanese Patent Application No. 2000-188857, filed Jun. 23, 2000, the entire contents of which are incorporated herein by reference.

### BACKGROUND OF THE INVENTION

1. Field of the Invention

The present invention relates to a semiconductor integrated circuit and a semiconductor apparatus system for determining a logical value at an input pin against the external reference potential. More specifically, the present invention relates to a semiconductor integrated circuit and a semiconductor apparatus system determining a logical value when a small voltage swing is generated at an input pin.

2. Description of the Related Art

In recent years, a semiconductor integrated circuit uses a small swing interface of approximately 1V or less for an external interface especially with the development of high-speed semiconductor memories as fast as 200 MHz or more. The small swing interface uses an external reference potential VREF for determining logical values corresponding to the H or L level at input pins such as an address pin, a data input pin, a clock input pin, and the like.

An input circuit (input receiver) in the semiconductor integrated circuit compares an input pin potential with a VREF pin potential. When the input pin potential is higher than the VREF pin potential, the logical value “H level” is detected; or the “L level” is detected for a semiconductor integrated circuit which uses the negative logic. Adversely, when the input pin potential is lower than the VREF pin potential, the logical value “L level” is detected; or the “H level” is detected for a semiconductor integrated circuit which uses the negative logic. A synchronous semiconductor integrated circuit such as synchronous DRAM uses the input receiver to acquire addresses and data synchronously with an external clock. The logical value “H level” or “L level” is determined by comparing the input pin potential with the VREF pin potential as well as by detecting a clock's leading or trailing edge, or both edges.

FIG. 13 is a block diagram showing an input circuit of a semiconductor integrated circuit using the prior art. An input receiver 100 is supplied with an external reference potential VREF input from a VREF pin 101 via a VREF terminal 102, data input from data pin 103 via a data input terminal 104, and a CLOCK signal input from an internal clock generation circuit 105 via a clock input terminal 106.

The input receiver 100 compares potentials between VREF and the data at the leading edge of an input CLOCK signal. When the data potential is higher than the VREF potential, an output terminal 107 asserts an H level signal. Adversely, when the data potential is lower than the VREF potential, the output terminal 107 asserts an L level signal. A capacitor 108 for suppressing VREF fluctuations is provided between a pin 101 and a ground potential.

The conventional semiconductor integrated circuit causes the following problems.

The setup and hold times for the input pin of the semiconductor integrated circuit depend on an external VREF potential. Adjusting the external VREF potential can minimize the setup and hold times and increase the VREF H-level and L-level margins. However, the external VREF potential cannot be changed in consideration of the other semiconductor integrated circuits that constitute the system and commonly use the VREF.

Incidentally, Jpn. Pat. Appln. KOKAI Publication No. 7-79149, especially in FIG. 1 thereof, describes a technique for increasing a noise margin by adjusting a comparison between high and low voltages for a signal input circuit according to a noise condition when the circuit is mounted on a printed circuit board. However, there is no description as to converting an external VREF level to another potential in the semiconductor integrated circuit and comparing and determining potentials in the input circuit.

### BRIEF SUMMARY OF THE INVENTION

It is an object of the present invention to provide a semiconductor integrated circuit that solves the above-mentioned problems of the prior art.

According to a first aspect of the present invention, there is provided a semiconductor integrated circuit comprising: a reference potential conversion circuit which is supplied with n−1 (n is 2 or larger natural number) external reference potentials (VREF1, VREF2, . . . , VREFn−1) and converts external reference potentials to generate n−1 internal reference potentials (VREFint1, VREFint2, . . . , VREFintn−1) differing from external reference potentials and having a relationship with regard to the n−1 external reference potentials, and an input circuit which is supplied with the internal reference potential (VREFint1, VREFint2, VREFintn−1) as reference potentials, is supplied with n values of data signals expressed by potentials, and compares a data signal and a reference potential to output a determination result.

In the semiconductor integrated circuit according to the first aspect of the present invention, the relationship between the external reference potentials (VREF1, VREFint2, . . . , VREFn−1) and the internal reference potentials (VREFint1, VREFint2, . . . , VREFintn−1) may be expressed by VREFintn−1=VREFn−1+A (n is 2 or larger natural number and A is a rational number except 0).

In the semiconductor integrated circuit according to the first aspect of the present invention, the relationship between the external reference potentials (VREF1, VREFint2, . . . , VREFn−1) and the internal reference potentials (VREFint1, VREFint2, . . . , VREFintn−1) may be expressed by VREFintn−1=B×VREFn−1 (n is 2 or larger natural number and B is a rational number except 0).

In the semiconductor integrated circuit according to the first aspect of the present invention, the relationship between the external reference potentials (VREF1, VREFint2, . . . , VREFn−1) and the internal reference potentials (VREFint1, VREFint2, . . . , VREFintn−1) may be expressed by VREFintn−1=C×VREFn−1 +D (n is 2 or larger natural number and, C and D are rational numbers except 0).

In the semiconductor integrated circuit according to the first aspect of the present invention, the semiconductor integrated circuit may further comprise a storage circuit for holding data of a plurality of bits, and wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the storage circuit. The storage circuit for holding data of a plurality of bits may be a one-time programmable storage circuit, and the relationship between the external reference potentials (VREF1, VREFint2, . . . , VREFn−1) and the internal reference potentials (VREFint1, VREFint2, . . . , VREFintn−1) may be changed based on data of a plurality of bits stored in the storage circuit. The one-time programmable storage circuit may include a laser beam blown type fuse for specifying data of a plurality of bits to be held depending on whether a laser beam disconnects the fuse, and the relationship between the external reference potentials (VREF1, VREF2, . . . , VREFn−1) and the internal reference potentials (VREFint1, VREFint2, . . . , VREFintn−1) may be changed based on data of a plurality of bits stored in the laser beam blown type fuse. The one-time programmable storage circuit may include an electric current blown type fuse for specifying data of a plurality of bits to be held depending on whether an electric current disconnects the fuse, and the relationship between the external reference potentials (VREF1, VREF2, . . . , VREFn−1) and the internal reference potentials (VREFint1, VREFint2, . . . , VREFintn−1) may be changed based on data of a plurality of bits stored in the electric current blown type fuse. The one-time programmable storage circuit may include a dielectric film breakdown type fuse for specifying data of a plurality of bits to be held depending on whether a voltage breakdowns a dielectric film of the dielectric film breakdown type fuse, and the relationship between the external reference potentials (VREF1, VREF2, . . . , VREFn−1) and the internal reference potentials (VREFint1, VREFint2, . . . , VREFintn−1) may be changed based on data of a plurality of bits stored in the dielectric film breakdown type fuse.

In the semiconductor integrated circuit according to the first aspect of the present invention, the semiconductor integrated circuit may further comprise a storage circuit for holding data of a plurality of bits, wherein the storage circuit for holding data of a plurality of bits may be a reprogrammable storage circuit, and the relationship between the external reference potentials (VREF1, VREFint2, . . . , VREFn−1) and the internal reference potentials (VREFint1, VREFint2, . . . , VREFintn−1) may be changed based on data of a plurality of bits stored in the reprogrammable storage circuit. The reprogrammable storage circuit may include a semiconductor memory circuit for specifying data of a plurality of bits to be held, wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the semiconductor memory circuit. The reprogrammable storage circuit may include a register for specifying data of a plurality of bits to be held, wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the register.

In the semiconductor integrated circuit according to the first aspect of the present invention, the semiconductor integrated circuit may further comprise a first storage circuit for holding data of a plurality of bits and a second storage circuit for holding data of a plurality of bits, wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the first storage circuit or the second storage circuit. The semiconductor integrated circuit may further comprise a selection circuit for selecting the first storage circuit or the second storage circuit, wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the first storage circuit or the second storage circuit selected by the selection circuit. The input circuit may compare an input data signal with the reference potential having n−1 values at the timing of a clock signal's leading and trailing edge or either edge and outputs a comparison result.

In the semiconductor integrated circuit according to the first aspect of the present invention, the semiconductor integrated circuit may further comprise a selection circuit for selecting the first storage circuit or the second storage circuit, wherein the relationship between the external reference potentials (VREF1, VREF2, . . . , VREFn−1) and the internal reference potentials (VREFint1, VREFint2, . . . , VREFintn−1) may be changed based on data of a plurality of bits stored in the first storage circuit or the second storage circuit selected by the selection circuit.

In the semiconductor integrated circuit according to the first aspect of the present invention, the semiconductor integrated circuit may further comprise a storage circuit for holding data of a plurality of bits, and the input circuit may compare an input data signal with the reference potential having n−1 values at the timing of a clock signal's leading and trailing edge or either edge and outputs a comparison result.

In the semiconductor integrated circuit according to the first aspect of the present invention, the semiconductor integrated circuit may further comprise a first storage circuit for holding data of a plurality of bits and a second storage circuit for holding data of a plurality of bits, wherein the relationship between the external reference potentials (VREF1, VREFint2, . . . , VREFn−1) and the internal reference potentials (VREFint1, VREFint2, . . . , VREFintn−1) may be changed based on data of a plurality of bits stored in the first storage circuit or the second storage circuit, and the input circuit compares an input data signal with the reference potential having n−1 values at the timing of a clock signal's leading and trailing edge or either edge and outputs a comparison result.

According to a second aspect of the present invention, there is provided a semiconductor apparatus system, comprising: a motherboard including an input/output terminal section and a data signal line and an external reference signal line connected to this input/output terminal section, and a plurality of semiconductor integrated circuits which is mounted on the motherboard and includes a reference potential conversion circuit connected to the external reference signal line, supplied with n−1 (n is 2 or larger natural number) external reference potentials (VREF1, VREFint2, . . . , VREFn−1), and generating other potentials (VREFint1, VREFint2, . . . , VREFintn−1) differing from the external reference potentials and further includes an input circuit supplied with output potentials (VREFint1, VREFint2, . . . . VREFintn−1) from the reference potential conversion circuit as reference potentials, supplied with a data signal from the data signal line, comparing the input data signal with reference potentials having n−1 values for determination, and generating a determination result.

In the semiconductor apparatus system according to the second aspect of the present invention, the semiconductor integrated circuit may further comprise a storage circuit for holding data of a plurality of bits, and the relationship between the external reference potentials (VREF1, VREF2, . . . , VREFn−1) and the internal reference potentials (VREFint1, VREFint2, . . . , VREFintn−1) may be changed based on data of a plurality of bits stored in the storage circuit.

In the semiconductor apparatus system according to the second aspect of the present invention, the semiconductor integrated circuit may further comprise a first storage circuit for holding data of a plurality of bits, and a second storage circuit for holding data of a plurality of bits, and the relationship between the external reference potentials (VREF1, VREF2, . . . , VREFn−1) and the internal reference potentials (VREFint1, VREFint2, . . . , VREFintn−1) may be changed based on data of a plurality of bits stored in the first storage circuit or the second storage circuit.

In the semiconductor integrated circuit according to the second aspect of the present invention, the semiconductor integrated circuit may further comprise a selection circuit for selecting the first storage circuit or the second storage circuit, and the relationship between the external reference potentials (VREF1, VREFint2, . . . , VREFn−1) and the internal reference potentials (VREFint1, VREFint2, . . . , VREFintn−1) may be changed based on data of a plurality of bits stored in the first storage circuit or the second storage circuit selected by the selection circuit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a block diagram showing a configuration of a semiconductor integrated circuit according to a first embodiment of the present invention;

FIG. 2 is a circuit diagram of a reference potential conversion circuit of the semiconductor integrated circuit according to the first embodiment of the present invention;

FIG. 3 is a circuit diagram of an input receiver of the semiconductor integrated circuit according to the first embodiment of the present invention;

FIG. 4 shows operational waveforms of the semiconductor integrated circuit according to the first embodiment of the present invention;

FIG. 5 is a Schmoo plot for acquiring H level data at an odd-numbered cycle of the semiconductor integrated circuit according to the first embodiment of the present invention;

FIG. 6 is a Schmoo plot for acquiring L level data at an even-numbered cycle of the semiconductor integrated circuit according to the first embodiment of the present invention;

FIG. 7 is a composite Schmoo plot of FIGS. 5 and 6 of the semiconductor integrated circuit according to the first embodiment of the present invention;

FIG. 8 is a block diagram showing a configuration of a modification of the semiconductor integrated circuit according to the first embodiment of the present invention;

FIG. 9 is a circuit diagram of a reference potential conversion circuit of a semiconductor integrated circuit according to a second embodiment of the present invention;

FIG. 10 is a block diagram showing a configuration of a semiconductor integrated circuit according to a third embodiment of the present invention;

FIG. 11 is a circuit diagram of a reference potential conversion circuit of the semiconductor integrated circuit according to the third embodiment of the present invention;

FIG. 12 is a perspective view showing a configuration of a semiconductor apparatus system according to a fourth embodiment of the present invention; and

FIG. 13 is a block diagram showing an input circuit of a conventional semiconductor integrated circuit.

### DETAILED DESCRIPTION OF THE INVENTION

A voltage index and a time index are used for expressing performance of the semiconductor integrated circuit's input receiver.

The voltage index corresponds to the H level margin and the L level margin of VREF. A semiconductor integrated circuit may use the external reference potential VREF as a reference potential for determining logical values for input pins such as an address pin, a data input pin, and the like. On such a circuit, the input receiver compares the VREF potential with the input pin potential.

For example, it is assumed that the semiconductor integrated circuit operates with the input pin's H level potential of 2.0V, the L level potential of 1.0V, and the VREF potential of 1.5V. The VREF potential is changed to test the semiconductor integrated circuit, with the input pin's H level potential and L level potential unchanged. In the test, the VREF potential is increased to determine the highest VREF potential at which the semiconductor integrated circuit can operate. Also, in the test, the VREF potential is decreased to determine the lowest VREF potential at which the semiconductor integrated circuit can operate. Ideally, the VREF potential should range from, say, 1.01V, a value slightly higher than the input pin's L level potential (1.0V) to, say, 1.99V, a value slightly lower than the input pin's H level potential (2.0V). However, the actual VREF potential capable of operating the semiconductor integrated circuit is narrowed by input signal overshooting or undershooting, VREF potential fluctuation, power supply fluctuation, the input receiver characteristic, and the like.

For example, it is assumed that an operational VREF potential ranges from 1.3V to 1.9V under a certain condition. Since the external reference potential VREF set to 1.5V, decreasing the VREF leaves a voltage margin of 0.2V by subtracting 1.3V from 1.5V. This is called a VREF L level margin. Namely, the VREF L level margin specifies an extent to which the external VREF potential can be decreased for ensuring correct acquisition of the input pin's L level.

Increasing the VREF leaves a voltage margin of 0.4V by subtracting 1.5V from 1.9V. This is called a VREF H level margin. Namely, the VREF H level margin specifies an extent to which the external VREF potential can be increased for ensuring correct acquisition of the input pin's H level. In this case, the VREF H level margin is greater than the VREF L level margin by 0.2V.

Here, the semiconductor integrated circuit uses a margin for the VREF H or L level, whichever is smaller. When the VREF H level margin becomes equal to the VREF L level margin, the semiconductor integrated circuit is given the maximum VREF margin. In this example, the maximum VREF margin is given when the VREF 1.6V. In this time, the VREF H level margin is 0.3V and the VREF L level margin is 0.3V, and the VREF margin of the semiconductor integrated circuit becomes maximum. The VREF margin for the chip can be improved by increasing the VREF potential from 1.5V to 1.6V. However, the VREF shared by a plurality of semiconductor integrated circuits in an ordinary system comprising dozens of semiconductor memories on the motherboard. The VREF potential cannot be modified just in order to improve the efficiency of a specific semiconductor integrated circuit.

On the other hand, a setup time and a hold time are used as time indexes for expressing performance of the input receiver on the semiconductor integrated circuit. The setup time specifies a period before a clock's leading or trailing edge for stabilizing the input pin state (potential) so that the input receiver of the semiconductor integrated circuit can correctly acquire data at the input pin. In other words, when data to be acquired is at H level, the setup time specifies a period before a clock's leading or trailing edge for establishing the high level of the input pin state so that the input receiver of the semiconductor integrated circuit can correctly acquire the H level data. When data to be acquired is at L level, the setup time specifies a period before a clock's leading or trailing edge for establishing the L level of the input pin state so that the input receiver of the semiconductor integrated circuit can correctly acquire the L level data. The hold time specifies a period after a clock's leading or trailing edge for retaining the input pin state (potential) so that the input receiver of the semiconductor integrated circuit can correctly acquire data at the input pin. In other words, when data to be acquired is at H level, the hold time specifies a period after a clock's leading or trailing edge for keeping the input pin state to H level so that the input receiver of the semiconductor integrated circuit can correctly acquire the H level data. When data to be acquired is at L level, the hold time specifies a period after a clock's leading or trailing edge for keeping the input pin state to L level so that the input receiver of the semiconductor integrated circuit can correctly acquire the L level data.

The shorter the setup time and the hold time take effect, the more the input receiver maintains high-speed performance. When H level data is acquired, the input data changes from L, H, and then to L levels. When L level data is acquired, the input data changes from H, L, and then to H levels. Ideally, the setup and hold times for acquiring the H level data should equal those for acquiring the L level data. Practically, however, either is more degraded than the other. External input data contains H and L levels. The setup and hold times for the semiconductor integrated circuit are adjusted to those for acquiring the H level data or those for acquiring the L level data whichever are less favorable.

The setup and hold times for acquiring the H level data and those for acquiring the L level data depend on the VREF potential. Decreasing the VREF potential increases a difference between the H level input potential and the VREF potential, making it easy to acquire H level data and improving the setup and hold times for acquiring H level data. Adversely, this decreases a difference between the L level input potential and the VREF potential, making it difficult to acquire L level data and degrading the setup and hold times for acquiring L level data. Further, increasing the VREF potential improves the setup and hold times for acquiring L level data and degrades those for acquiring H level data.

As mentioned above, the setup and hold times for acquiring L level data are complementary to those for acquiring H level data. Namely, when one is improved, the other is degraded. Minimizing the setup and hold times for the semiconductor integrated circuit just needs to equalize the setup and hold times for acquiring H level data with those for acquiring L level data. Also, as mentioned above, the setup and hold times for acquiring the H level data and those for acquiring the L level data depend on the VREF potential. Optimizing the VREF potential can equalize the setup and hold times for acquiring H level data with those for acquiring L level data.

However, if only the relevant semiconductor integrated circuit uses the VREF potential, the VREF potential can be optimized. Actually, the VREF potential is shared among other semiconductor integrated circuits on the system. The VREF potential cannot be modified just in order to improve the efficiency of a specific semiconductor integrated circuit. For example, it is assumed that a 1.5V VREF potential is commonly used in a system. It is known that the VREF potential of 1.6V provides the shortest setup and hold times with respect to a specific semiconductor integrated circuit. However, since the VREF potential of 1.5V is optimal for the other semiconductor integrated circuits on the system, the VREF potential of 1.5V cannot be changed to 1.6V. This is because said other semiconductor integrated circuits on the system may malfunction.

Embodiments of the present invention will be described in further detail with reference to the accompanying drawings. The mutually corresponding parts in the following figures are designated by the same or similar reference numerals.

[First Embodiment]

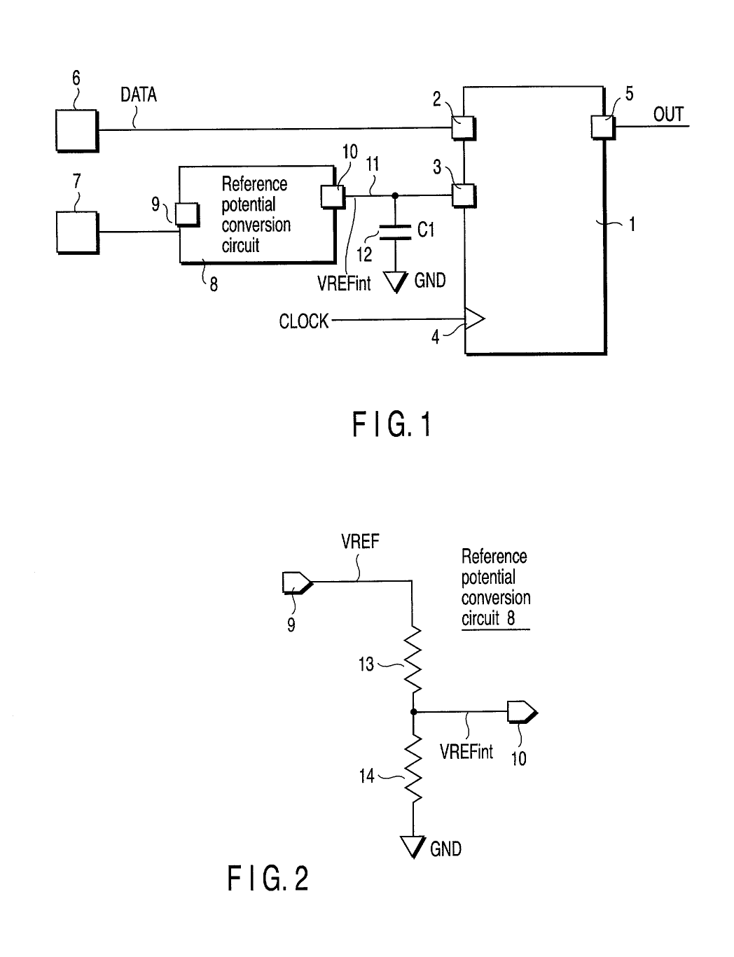

The following describes a semiconductor integrated circuit according to the first embodiment of the present invention with reference to FIG. 1.

FIG. 1 is a block diagram showing a configuration of a semiconductor integrated circuit according to the first embodiment of the present invention. FIG. 1 corresponds to an input circuit and its peripheral components in the semiconductor integrated circuit. In the case of a semiconductor memory device, signals are transmitted from here to a sense amplifier and the like in a memory cell region (not shown). An input receiver 1 is provided with four terminals: an input terminal 2, a REF terminal 3, a clock terminal 4, and an output terminal 5. The input receiver 1 compares a potential input from the input terminal 2 with a potential input from the REF terminal 3 at the leading edge of a CLOCK signal input from the clock terminal 4. When the potential of the input terminal 2 is higher than that of the REF terminal 3, the output terminal 5 asserts an H level output signal.

An external data terminal 6 is connected to the input terminal 2 of the input receiver 1. The clock terminal 4 is provided with a CLOCK signal which is supplied from the outside of the semiconductor integrated circuit or is generated in the semiconductor integrated circuit. An external VREF terminal 7 is connected to a REFIN terminal 9 of a reference potential conversion circuit 8. A REFOUT terminal 10, an output from the reference potential conversion circuit 8, is connected to a VREFint wiring 11 which carries an internal reference potential. The VREFint wiring 11 is connected to the REF terminal 3 of the input receiver 1. Here, a capacitor 12 is provided between the VREFint wiring 11 and a ground potential for suppressing a fluctuation of the internal reference potential VREFint.

FIG. 2 shows a detailed example of the reference potential conversion circuit 8. An input terminal REFIN 9 is connected to one terminal of a first resistor 13. The other terminal of the first resistor 13 is connected to a REFOUT terminal 10. One terminal of a second resistor 14 is connected to the REFOUT terminal 10. The other terminal thereof is connected to the ground potential. In this embodiment, the internal VREFint potential is 0.9 times larger than the external VREF potential. In the thus configured circuit, it is assumed that a ratio of the first resistor 13 to the second resistor 14 is 9:1. For example, the first resistor 13 is set to 9 kilo-ohm and the second resistor 14 is set to 1 kilo-ohm. Under this condition, a voltage of VREF×0.9 appears on the VREFint wiring 11. A voltage of VREFint=VREF×0.9 is applied to the REF terminal 3 of the input receiver 1.

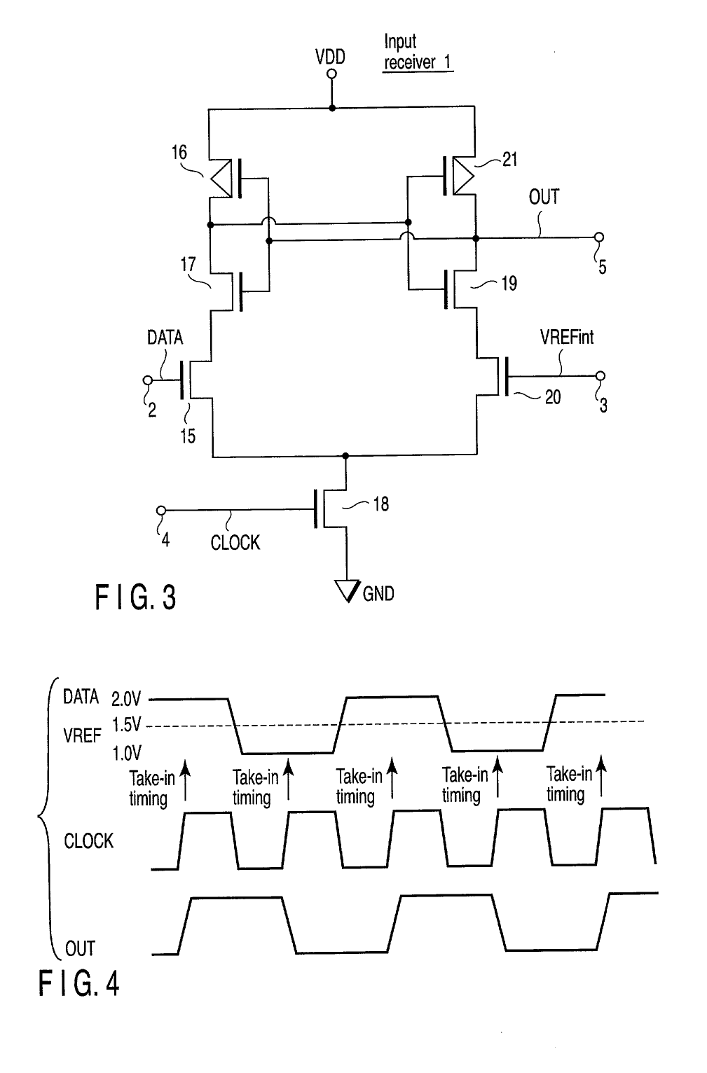

FIG. 3 shows a detailed example of the input receiver 1. The input receiver 1 includes first to fifth NMOS transistors 15, 17, 18, 19, and 20, and first and second PMOS transistors 16 and 21. In a first NMOS transistor 15, the gate is connected to an IN terminal 2. The drain is connected to a source of a second NMOS transistor 17. The drain of a second NMOS transistor 17 is connected to the drain of a first PMOS transistor 16. The gate is connected to an OUT terminal 5 and to the gate of the first PMOS transistor 16. The source of the first PMOS transistor 16 is connected to a power supply potential VDD. In a third NMOS transistor 18, the source is connected to the ground potential. The gate is connected to the clock terminal 4. The drain is connected to the source of the first NMOS transistor 15. In a fourth NMOS transistor 19, the drain is connected to the OUT terminal 5. The gate is connected to each drain of a second NMOS transistor 17 and the first PMOS transistor 16. In a fifth NMOS transistor 20, the gate is connected to the REF terminal 3. The source is connected to the drain of the third NMOS transistor 18. The drain is connected to the source of the fourth NMOS transistor 19. In a second PMOS transistor 21, the source is connected to the power supply potential. The drain is connected to the OUT terminal 5. The gate is connected to the drain of the first PMOS transistor 16, to the drain of the second NMOS transistor 17, and to the gate of the fourth NMOS transistor 19.

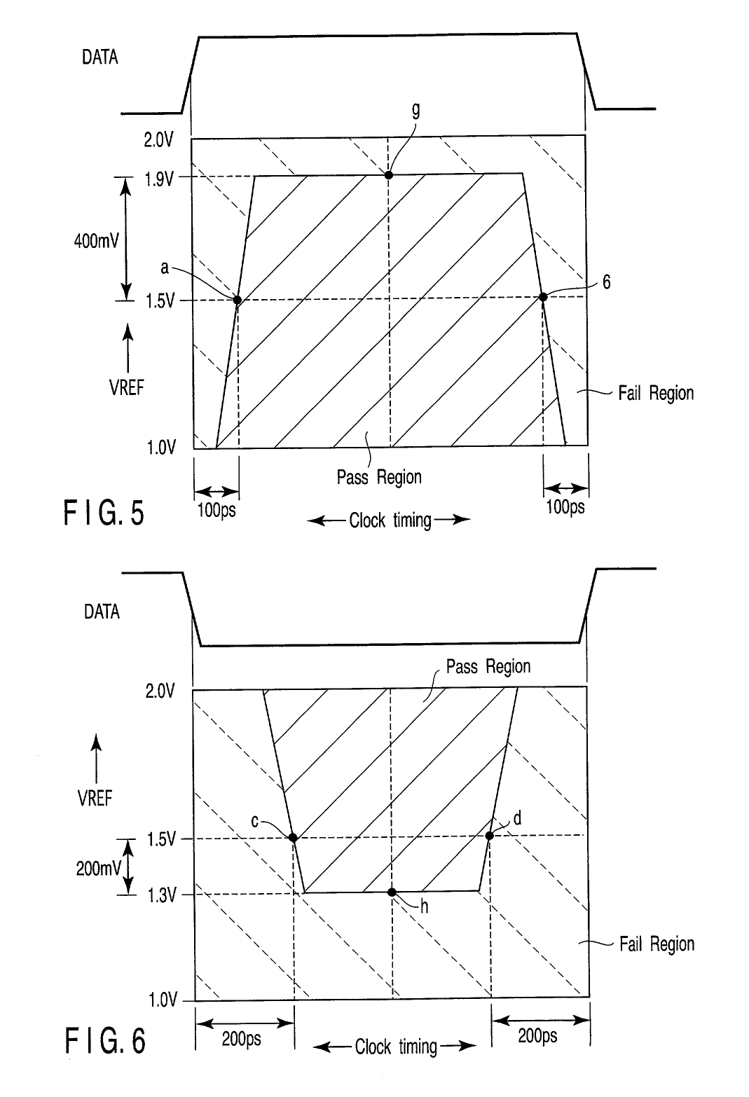

FIG. 4 shows operational waveforms of the circuit in FIG. 1. In this example, the potential VREF of the external VREF terminal 7 is constantly set to 1.5V. The external data terminal 6 is supplied with a signal having the L level potential of 1.0V, the H level potential of 2.0V, and the swing of 1.0V. Since a data potential is greater than the VREF potential at the first leading edge of the CLOCK signal, the output terminal 5 asserts an H level signal. Since the data potential is smaller than the VREF potential at the second leading edge of the CLOCK signal, the output terminal 5 asserts an L level signal. Subsequently, this operation is repeated to acquire the H level at an odd-numbered leading edge of the CLOCK signal and acquire the L level at an even-numbered leading edge of the CLOCK signal. In the thus configured semiconductor integrated circuit, a signal from the output terminal 5 is tested by advancing or delaying timing of the CLOCK signal's leading edge with reference to the data pin timing and increasing and decreasing a potential input from the external VREF terminal 7. The test results are shown in FIGS. 5, 6 and 7.

FIG. 5 shows a Schmoo plot for determining a pass condition when the H level is correctly acquired at an odd-numbered leading edge of the CLOCK signal, that is, when a correct acquisition is performed, or determining a fail condition when the L level is erroneously acquired, that is, when an erroneous acquisition is performed. In FIG. 5, the pass region is marked with solid diagonal lines. The fail region is marked with broken diagonal lines outside the pass region. This Schmoo plot uses the vertical axis to indicate a potential VREF of the external VREF terminal 7 and uses the horizontal axis to indicate a leading edge timing of the clock terminal 4. In the Schmoo plot, the left end of the horizontal axis corresponds to a time at which the input terminal 2 changes from the L level to the H level. The right end of the horizontal axis corresponds to a time at which the input terminal 2 changes from the H level to the L level. The center of the horizontal axis corresponds to a time at which the CLOCK signal's leading edge comes to the center of the potential transition timing at the input terminal 2 (see the data waveform on the Schmoo plot). On this Schmoo plot, a boundary is formed between the pass region and the fail region. Intersecting points are found between the boundary and a potential line of 1.5V at the external VREF terminal 7. The left intersecting point is assumed to be point “a”. The right intersecting point is assumed to be point “b”.

A time difference between the left end and point “a” on the Schmoo plot specifies a period before the CLOCK signal's leading edge for enabling the H level of the input terminal 2 to correctly acquire H level data. Namely, this time difference is equivalent to the setup time for H level data acquisition. A time difference between the right end and point “b” on the Schmoo plot specifies a period after the CLOCK signal's leading edge for keeping the H level of the external data terminal 6 to correctly acquire H level data. Namely, this time difference is equivalent to the hold time for H level data acquisition. FIG. 5 specifies the 100 ps setup time and the 100 ps hold time for acquiring H level data.

A boundary is formed between the pass region and the fail region. When a vertical line is extended upward perpendicularly to the center of the horizontal axis, the vertical line intersects that boundary to form an intersecting point “g”. Point “g” corresponds to a time of the CLOCK signal's leading edge. There is a potential difference of 400 mV between point “g” and the potential line of 1.5V at the external VREF terminal 7. This potential difference indicates an allowable amount of the potential at the external VREF terminal 7 over 1.5V for ensuring correct acquisition of H level data. Namely, this potential difference is equivalent to the VREF H level margin.

FIG. 6 shows a Schmoo plot for determining a pass condition when the L level is correctly acquired at an even-numbered leading edge of the CLOCK signal or determining a fail condition when the H level is erroneously acquired. In FIG. 6, the pass region is marked with solid lines. The fail region is marked with broken lines outside the pass region. This Schmoo plot uses the vertical axis to indicate a potential of the external VREF terminal 7 and uses the horizontal axis to indicate a leading edge timing of the clock terminal 4. In the Schmoo plot, the left end of the horizontal axis corresponds to a time at which the input terminal 2 changes from the H level to the L level. The right end of the horizontal axis corresponds to a time at which the input terminal 2 changes from the L level to the H level. The center of the horizontal axis corresponds to a time at which the CLOCK signal's leading edge comes to the center of the potential transition timing at the input terminal 2 (see the data waveform on the Schmoo plot).

On this Schmoo plot, a boundary is formed between the pass region and the fail region. Intersecting points are found between the boundary and a potential line of 1.5V at the external VREF terminal 7. The left intersecting point is assumed to be point “c”. The right intersecting point is assumed to be point “d”. A time difference between the left end and point “c” on the Schmoo plot specifies a period before the clock's leading edge for enabling the L level of the input terminal 2 to correctly acquire L level data. Namely, this time difference is equivalent to the setup time for L level data acquisition.

A time difference between the right end and point “d” on the Schmoo plot specifies a period after the CLOCK signal's leading edge for keeping the L level of the external data terminal 6 to correctly acquire L level data. Namely, this time difference is equivalent to the hold time for L level data acquisition. FIG. 6 specifies the 200 ps setup time and the 200 ps hold time for acquiring H level data. A boundary is formed between the pass region and the fail region. When a vertical line is extended downward perpendicularly to the center of the horizontal axis, the vertical line intersects that boundary to form an intersecting point “h”. Point “h” corresponds to a moment of the CLOCK signal's trailing edge. There is a potential difference of 200 mV between point “h” and the potential line of 1.5V at the external VREF terminal 7. This potential difference indicates an allowable amount of the potential at the external VREF terminal 7 below 1.5V for ensuring correct acquisition of L level data. Namely, this potential difference is equivalent to the VREF L level margin.

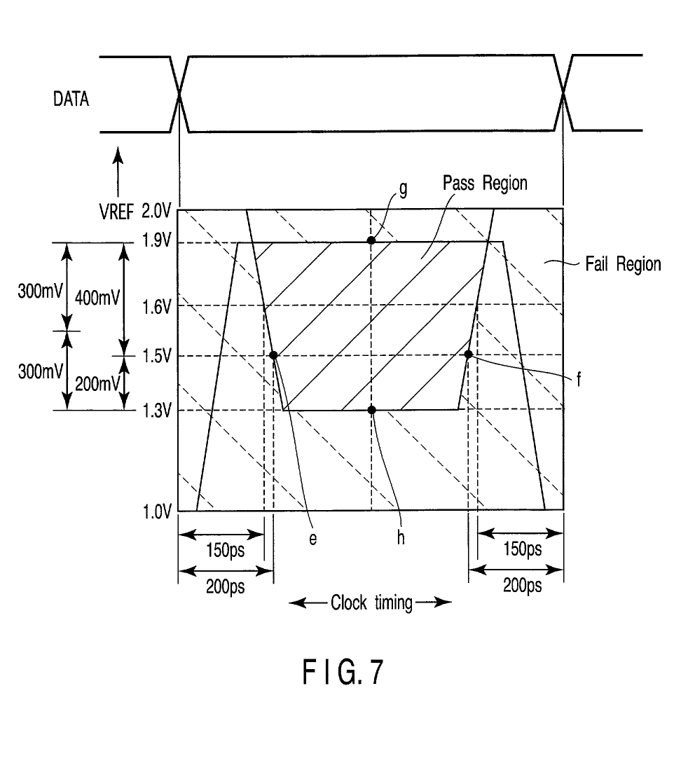

FIG. 7 is a composite Schmoo plot of FIGS. 5 and 6. The pass region in this Schmoo plot ensures correct acquisition of data for the semiconductor integrated circuit. On this Schmoo plot, a boundary is formed between the pass region and the fail region. Intersecting points are found between the boundary and a potential line of 1.5V at the external VREF terminal 7. The left intersecting point is assumed to be point “e”. The right intersecting point is assumed to be point “If”. A time difference between the left end and point “e” on the Schmoo plot specifies a period before the CLOCK signal's leading edge for enabling the input terminal 2 to correctly acquire data. Namely, this time difference is equivalent to the setup time. A time difference between the right end and point “f” on the Schmoo plot specifies a period after the CLOCK signal's leading edge for keeping the potential of the input terminal 2 to correctly acquire data. Namely, this time difference is equivalent to the hold time.

FIG. 7 specifies the 200 ps setup time and the 200 ps hold time. It is understood that this values is same as that for the setup and hold times for acquiring L level data in FIG. 6 (see the data waveform on the Schmoo plot). Namely, the setup and hold times for the semiconductor integrated circuit are rate-controlled by the setup and hold times for L level data acquisition. This figure shows, when the VREF potential is increased from 1.5V to 1.6V, it is possible to improve the setup and hold times up to 150 ps. Likewise, when the VREF potential is increased from 1.5V to 1.6V, it is possible to supply a 300 mV margin to the VREF's H and L levels each. That is, this figure shows that the setup and hold times depend on the VREF potential.

A typical system allows the VREF to be shared among a plurality of semiconductor integrated circuits. Accordingly, potentials cannot be changed just in order to improve the efficiency of a specific semiconductor integrated circuit. The use of this embodiment can change the VREF value corresponding to respective semiconductor integrated circuits and minimize the setup and hold times for each semiconductor integrated circuit. It is possible to provide same or approximate voltage margins during acquisition of H-level and L-level data by varying an internal reference potential and improve voltage margins during data acquisition for the semiconductor integrated circuit. Consequently, even if a noise on the signal line causes a fail condition, this embodiment increases the possibility of allowing the same condition to be passed. Since this embodiment needs just two additional resistor elements, applying the embodiment to large-scale integrated semiconductor circuits can achieve some economies of scale.

This embodiment is not limited to semiconductor memories, but may be also applied to integrated circuits comprising mixed memory chips and input circuit peripherals such as MPU.

It is possible to appropriately change a value of the internal reference potential VREFint by measuring the characteristic after installing the semiconductor integrated circuit on a motherboard.

[Modification of the First Embodiment]

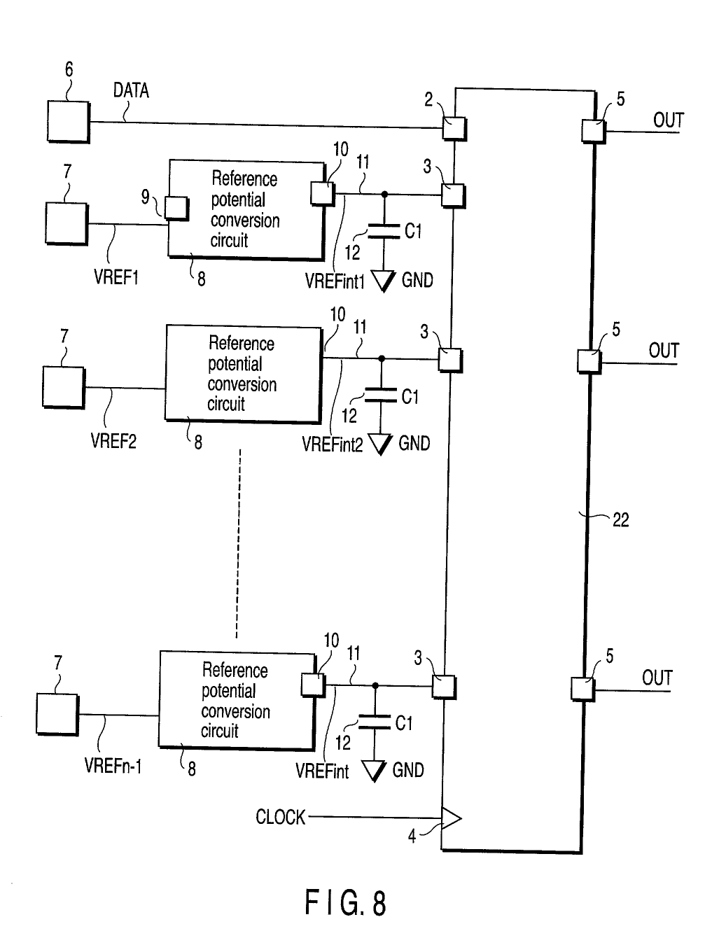

In this modification, as shown in FIG. 8, there are provided a plurality of circuits, i.e. n−1 circuits, each including the external VREF terminal 7, the external reference potential conversion circuit 8, the VREFint wirings 11, the capacitors 12, the REF terminals 3 and the output terminals 5, which are described in the first embodiment. The number n is a natural number and it is three or more in this modification. In this modification, n−1 external reference potentials are used to acquire n level data. Specifically, n level data is supplied to the input terminal 2 via the external data terminal 6, while n−1 external reference potentials are supplied to n−1 VREF terminals 7. For example, a three level data is supplied to the input terminal 2 via the external data terminal 6, while two different external reference potentials VREF1 and VREF2 are supplied to two VREF terminals 7. Correspondingly, the output terminals 5 generate output three level data.

This configuration can generate (n−1) internal reference potentials in correspondence to (n−1) external reference potentials and minimize the setup and hold times for the semiconductor integrated circuit. It is possible to provide same or approximate voltage margins during acquisition of H-level and L-level data by varying an internal reference potential and improve voltage margins during data acquisition for the semiconductor integrated circuit. The first embodiment has explained an example using two logical values for input data and a single external reference potential VREF. As mentioned above, the present invention is also applicable to a case using three or more logical values for input data and a plurality of external reference potential VREF values.

[Second Embodiment]

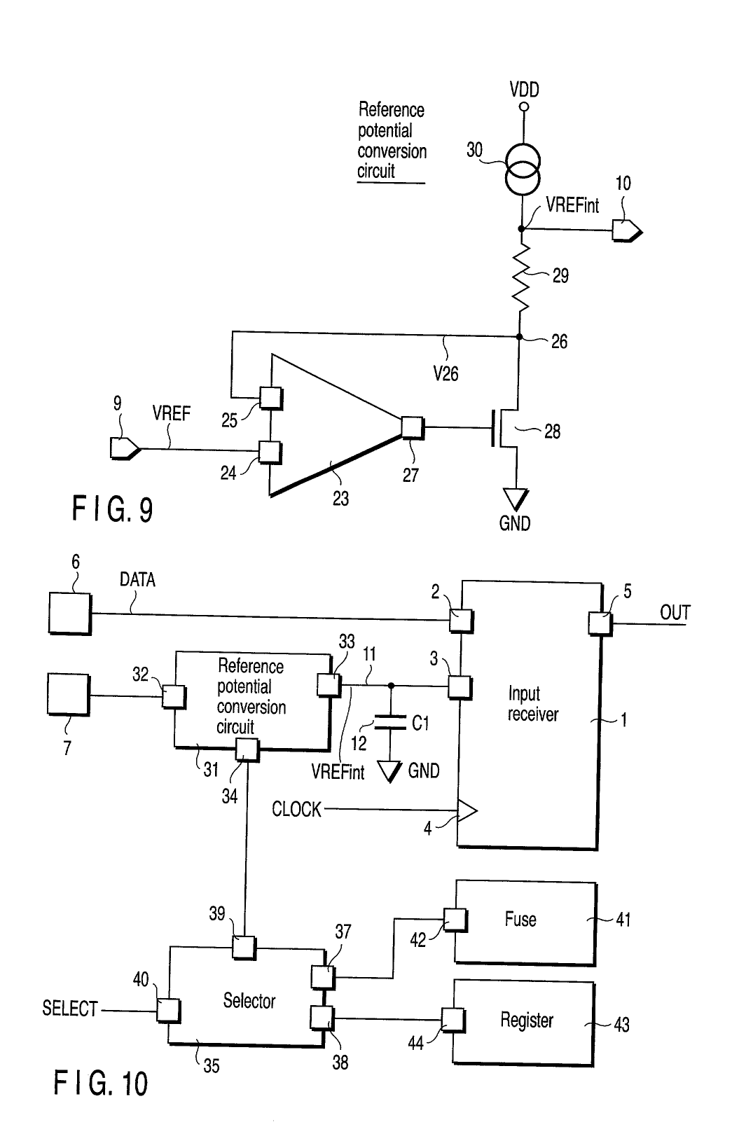

The following describes a case where an internal VREFint potential is higher than the VREF potential by 0.1V. A semiconductor integrated circuit according to this embodiment follows basically the same block diagram as for the semiconductor integrated circuit in FIG. 1 according to the first embodiment. Described below are details of the reference potential conversion circuit differing from the first embodiment. FIG. 9 shows a circuit diagram of the reference potential conversion circuit according to the second embodiment.

Here, the REFIN terminal 9 is connected to a negative terminal 24 of an operational amplifier 23. On the operational amplifier 23, a positive terminal 25 is connected to a REFCOPY node 26 in the reference potential conversion circuit. An output terminal 27 is connected to the gate terminal of an NMOS transistor 28. On the NMOS transistor 28, the drain terminal is connected to the REFCOPY node 26. The source terminal is connected to the ground potential. The REFCOPY node 26 is connected to one end of a resistor element 29 having the resistance value of, say, 1 kilo-ohm. The other end of the resistor element 29 is connected to the REFOUT terminal 10. The REFOUT terminal 10 is connected to a constant current source 30. The constant current source 30 supplies a constant current of, say, 100 μA.

For a semiconductor memory device, a memory cell needs a plurality of types of potentials which are generated inside the semiconductor memory. There is provided a plurality of constant current sources. This circuit configuration can be also used for input circuit peripherals to arrange the constant current sources.

When an input potential at the positive terminal 25 is higher than that at the negative terminal 24, the operational amplifier 23 outputs an H level from the output terminal 27. Otherwise, it outputs an L level. In this example, when the REFCOPY node 26 generates a higher potential V26 than the potential VREF of the REFIN terminal 9, the output terminal 27 becomes the H level. The NMOS transistor 28 turns on, decreasing the potential V26 of the REFCOPY node 26. On the contrary, when the REFCOPY node 26 generates a lower potential V26 than the potential VREF of the REFIN terminal 9, the output terminal 27 becomes the L level. The NMOS transistor 28 turns off, increasing the potential V26 of the REFCOPY node 26. Repeating these operations causes a balanced state, namely providing the same potential to the REFCOPY node 26 and the REFIN terminal 9.

Accordingly, the REFCOPY node 26 is supplied with the same potential as that for the REFIN terminal 9, namely the external reference potential VREF. Here, the constant current source 30 supplies a 100 μA current to the resistor element 29 and the NMOS transistor 28. Thus, both ends of the resistor element 29 produce a 0.1V potential which is a product of 1 kilo-ohm and 100 μA. As mentioned above, the potential of the REFCOPY node 26 is same as the external reference potential VREF. The REFOUT terminal 10 outputs a potential 0.1V higher than the VREF. Accordingly, the REF terminal 3 of the input receiver 1 is supplied with a VREFint potential equivalent to the VREF plus 0.1V. Unlike the first embodiment, the second embodiment can easily and finely generate an internal VREFint potential by varying a potential for the external VREF terminal 7 by means of addition.

A typical system allows the VREF to be shared among a plurality of semiconductor integrated circuits. Accordingly, potentials cannot be changed just in order to improve the efficiency of a specific semiconductor integrated circuit. The use of this embodiment can change the VREF value corresponding to respective semiconductor integrated circuits and minimize the setup and hold times for each semiconductor integrated circuit. Consequently, even if a noise on the signal line causes a fail condition, this embodiment increases the possibility of allowing the same condition to be passed. It is possible to provide same or approximate voltage margins at the acquisition of H-level and L-level data by varying an internal reference potential and improve voltage margins at the data acquisition for the semiconductor integrated circuit.

This embodiment is not limited to semiconductor memories, but may be also applied to integrated circuits comprising mixed memory chips and input circuit peripherals such as MPU.

It is possible to appropriately change a value of the internal reference potential VREFint by measuring the characteristic after installing the semiconductor integrated circuit on a motherboard.

It is possible to use VREFint, an output from the reference potential conversion circuit, as VREF according to the second embodiment and generate an internal reference voltage of VREFint=(VREF×0.9)+0.1V.

The present invention is also applicable to a case using three or more logical values for input data and a plurality of external reference potential VREF values by modifying this embodiment like the modification of the first embodiment.

[Third Embodiment]

The first and second embodiments have explained the examples in which there is fixed relationship between the external reference potential VREF and the internal reference potential VREFint. When environment for using the semiconductor integrated circuit is known, it is possible to provide this circuit with the relationship appropriate for the environment between the external reference potential VREF and the internal reference potential VREFint. Actually, there may be the case where it is impossible to determine under which environment the semiconductor integrated circuit is used. In such a case, it is also impossible to determine the relationship appropriate for the environment between the external reference potential VREF and the internal reference potential VREFint. The third embodiment exemplifies a semiconductor integrated circuit having a mechanism which can change the relationship between the external reference potential VREF and the internal reference potential VREFint by means of programming through the use of fuses or register sets.

FIG. 10 is a block diagram showing a configuration of a semiconductor integrated circuit according to the third embodiment. The input receiver 1 has the same configuration as that for the first embodiment. On the input receiver 1, the input terminal 2 connects with the external data terminal 6. The CLOCK terminal 4 connects with a CLOCK signal which is supplied from the outside of the semiconductor integrated circuit or is generated in the semiconductor integrated circuit. The external VREF terminal 7 is connected to a REFIN terminal 32 of a reference potential conversion circuit 31. The reference potential conversion circuit 31 has three terminals: a REFIN terminal 32, a REFOUT terminal 33, and a CTRL terminal 34. A signal input from the CTRL terminal 34 converts a potential input from the REFIN terminal 32 to another potential for output from the REFOUT terminal 33.

The REFOUT terminal 33 is an output from the reference potential conversion circuit 31 and is connected to the internal reference potential VREFint wiring 11. The internal reference potential VREFint wiring 11 is connected to the REF terminal 3 of the input receiver 1. The CTRL terminal 34 of the reference potential conversion circuit 31 is supplied with a CTRL signal from the selector 35 via a CTROL wiring 36. The selector 35 has four terminals: a first input terminal 37, a second input terminal 38, an output terminal 39, and a SELECT terminal 40. Based on the SELECT signal input from the SELECT terminal 40, the selector outputs a signal from the first input terminal 37 or the second input terminal 38 to the output terminal 39. In this embodiment, it is assumed that the output terminal 39 asserts an input signal from the first input terminal 37 when the SELECT signal is set to the L level or from the second input terminal 38 when the SELECT signal is set to the H level. Also, in this embodiment, an output signal from a fuse 41 is inputted to the first input terminal 37 of the selector 35.

The fuse 41 is an irreversible, i.e. one-time programmable, storage element such as a laser-blown fuse, an electrically blown fuse, or a dielectric breakdown fuse. This type of element cannot erase information once written. In this example, the fuse 41 is assumed to be able to store 3-bit information. An output terminal 42 of the fuse outputs a signal to the selector 35. The second input terminal 38 of the selector 35 is supplied with an output signal from a register 43. The register 43 indicates a reversible, i.e. reprogrammable, storage element such as a DRAM element, an SRAM element, a BPROM element, a flip-flop, or the like. This type of element can rewrite already written information. In this example, the register 43 is assumed to be able to store 3-bit information. An output terminal 44 of the register 43 outputs a signal to the selector 35.

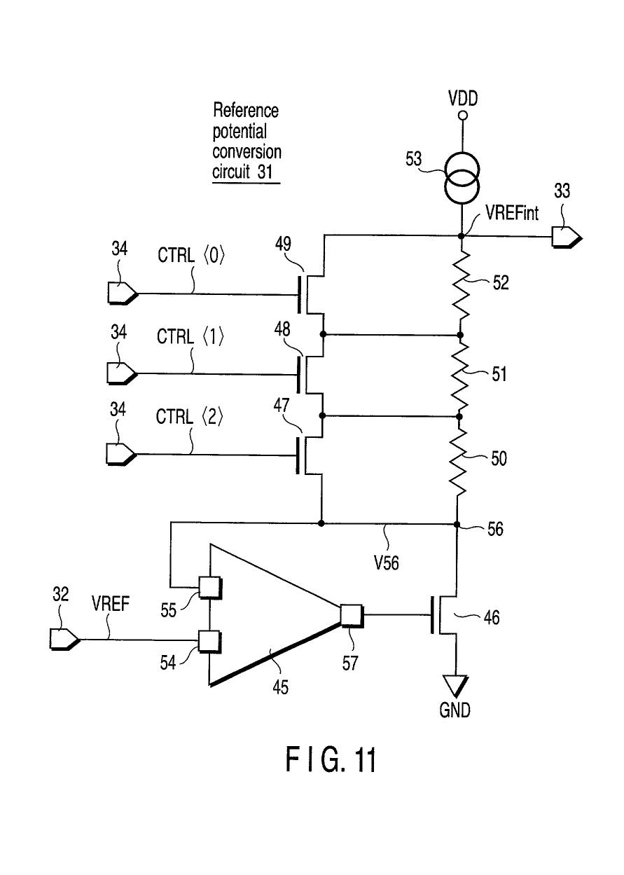

FIG. 11 is a circuit diagram of the reference potential conversion circuit 31 according to this embodiment. For example, the reference potential conversion circuit 31 includes an operational amplifier 45, first to fourth NMOS transistors 46, 47, 48, and 49, first to third resistor elements 50, 51, and 52, and a constant current source 53. The REFIN terminal 32 of the reference potential conversion circuit 31 is connected to a negative terminal 54 of the operational amplifier 45. On the operational amplifier 45, a positive terminal 55 is connected to a REFCOPY node 56 in the reference potential conversion circuit 31. An output terminal 57 is connected to the gate terminal of the NMOS transistors 46. On the first NMOS transistor 46, the drain terminal is connected to the REFCOPY terminal 56. The source terminal is connected to the ground potential.

The constant current source 53 supplies a constant current of, say, 10 μA. The first to third resistor elements 50, 51, and 52 are resistor elements having resistance values of, say, 1, 2, and 4 kilo-ohms, respectively. When an input potential at the positive terminal 55 is higher than that at the negative terminal 54, the operational amplifier 45 outputs an H level potential signal from the output terminal 57. Otherwise, it outputs an L level potential signal.

In this embodiment, when the REFCOPY node 56 generates a higher potential V56 than the potential VREF of the REFIN terminal 32, the output terminal 57 becomes the H level. The first NMOS transistor 46 turns on, decreasing the potential V56 of the REFCOPY node 56. On the contrary, when the REFCOPY node 56 generates a lower potential V56 than the potential VREF of the REFIN terminal 32, the output terminal 57 becomes the L level. The first NMOS transistor 46 turns off, increasing the potential V56 of the REFCOPY node 56. Repeating these operations causes a balanced state, namely providing the same potential to the REFCOPY node 56 and the REFIN terminal 32. On the balanced state, the REFCOPY node 56 is supplied with the same potential as that for the REFIN terminal 32, namely a potential equal to the external reference potential VREF. Since this example stores 3-bit information, a 3-bit CTRL signal is input from the CTRL terminal 34 of the reference potential conversion circuit 31. This signal comprises three bits CTRL <0>, CTRL <1>, and CTRL <2> which are connected to gates of the second to fourth NMOS transistors 47, 48, and 49, respectively. It is assumed that on-resistance values for the NMOS transistors 47, 48, and 49 are negligible.

When CTRL <0>=CTRL <1>=CTRL <2>=H level, for example, the second to fourth NMOS transistors 47, 48, and 49 go on. A current from the constant current source 53 passes the second to fourth NMOS transistors 47, 48, and 49, not the first to third resistor elements 50, 51, and 52. As mentioned above, the second to fourth NMOS transistors 47, 48, and 49 provide negligible on-resistance values. The potential of the REFOUT terminal 33 equals that of the REFCOPY node 56. The REFOUT terminal 33 is supplied with the same potential as that for the REFIN terminal 32, namely a potential equal to the external reference potential VREF.

When CTRL <0>=CTRL <1>=CTRL <2>=L level, the second to fourth NMOS transistors 47, 48, and 49 go off. The constant current source 53 supplies a 10 μA current to the first to third resistor elements 50, 51, and 52 and the first NMOS transistor 46. In this case, both ends of the first to third resistor elements 50, 51, and 52 are subject to potentials of 10 mV, 20 mV, and 40 mV, respectively. As mentioned above, the voltage for the REFCOPY node 56 equals the external reference potential VREF. The REFOUT terminal 33 outputs a potential 70 mV higher than the external reference potential VREF. By combining CTRL signals, it is possible to allow the REFOUT terminal 33 to output potentials from the VREF to the VREF+70 mV in increments of 10 mV. Table 1 below shows the relationship among combinations of H-level or L-level CTRL signals and potentials at the REFOUT terminal 33.

TABLE 1

| | | | Potential on |
|---|---|---|---|
| CTRL<2> | CTRL<1> | CTRL<0> | REFOUT terminal 33 |
| 0 | 0 | 0 | VREF + 70 mV |
| 0 | 0 | 1 | VREF + 60 mV |
| 0 | 1 | 0 | VREF + 50 mV |
| 0 | 1 | 1 | VREF + 40 mV |
| 1 | 0 | 0 | VREF + 30 mV |
| 1 | 0 | 1 | VREF + 20 mV |
| 1 | 1 | 0 | VREF + 10 mV |
| 1 | 1 | 1 | VREF |

After the semiconductor integrated circuit having the circuit in FIG. 10 is installed on a system, data “111” is written to the register 43. It may be preferable to install the register 43 only on a specific semiconductor apparatus on the motherboard and connect the specific semiconductor apparatus to the other semiconductor apparatuses on the motherboard via a control bus formed thereon. It may be also preferable to provide each semiconductor apparatus with a register. The SELECT signal is set to the H level for transferring data “111” written in the register 43 to the CTRL terminal 34. On the reference potential conversion circuit 31, the potential of the REFOUT 33 becomes equal to that of the REFIN 32. Accordingly, the internal VREFint potential equals the external reference potential VREF.

With this state, the external reference potential VREF is increased and decreased to measure a VREF potential margin. As a result, it is assumed that the following is proved. Namely, the system makes the VREF H level margin and the VREF L level margin equal to each other when the internal reference potential VREFint potential is set to a value 50 mV higher than the external reference potential VREF. The VREF margin also becomes widest for the entire system. In this case, data “0101 is written to the fuse 41 or the register 43 as shown in Table 1. When data recorded in the fuse 41 is used, the SELECT signal is set to the L level. When data recorded in the register 43 is used, the SELECT signal is set to the H level. After writing data “0101 to the fuse 41 or the register 43, the internal VREFint potential keeps the value 50 mV higher than the external reference potential VREF, increasing the VREF potential margin for the entire system.

It is possible to provide same or approximate setup and hold times at the time of acquisition of H-level and L-level data by varying an internal reference potential for each semiconductor integrated circuit and improve the setup and hold times for the semiconductor integrated circuit. Further, it is possible to provide same or approximate voltage margins at the time of acquisition of H-level and L-level data by varying an internal reference potential and improve the voltage margin at the time of data acquisition for the semiconductor integrated circuit.

When a laser-blown fuse is used for the fuse 41, the fuse must be disconnected when the device is at the wafer state. After the semiconductor integrated circuit is packaged, it is impossible to disconnect the fuse to record data. As a solution, several systems are fabricated experimentally by installing that semiconductor integrated circuit. The VREF potential margins are measured to find an optimal combination of CTRL signals. This combination of data is applied during a process of operating the laser-blown fuse on the wafer in the subsequent lot.

The use of an electrically blown fuse or a dielectric breakdown fuse makes it possible to install the semiconductor integrated circuit on the system, measure the VREF voltage margins, and then record an optimal combination of CTRL signals. There is an advantage of using an optimal combination of CTRL signals for the combination of the semiconductor integrated circuit and the system.

When a register is used instead of a fuse, a combination of CTRL signals can be changed at any time. When the semiconductor integrated circuit is installed on a give system, then on another system subsequently, there is an advantage of updating to an optimal combination of CTRL signals for the new system.

[Fourth Embodiment]

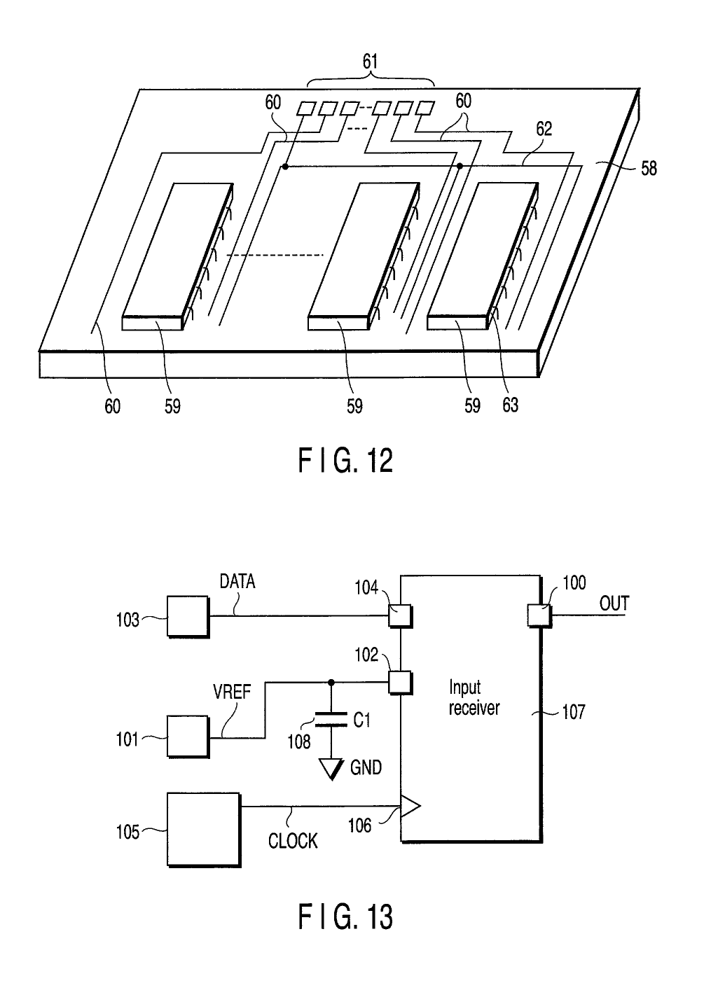

This embodiment installs a plurality of semiconductor integrated circuits, say, 20 circuits according to the first to third embodiments on a motherboard. As shown in FIG. 12, semiconductor integrated circuits 59 are provided on a motherboard 58. Furthermore, there are provided an address signal line, a data line, and a clock signal line 60 on the motherboard 58. Also, a VREF signal wiring 62 is provided on the motherboard 58. Along an edge on the surface of the motherboard 58, there is provided an input/output terminal section 61 for inputting and outputting signals with an external system. An external reference potential VREF supplied to each semiconductor integrated circuit 59 from the input/output terminal section 61 via the VREF signal wiring 62. A lead 63 of each semiconductor integrated circuit is actually connected to the address signal line, the data line, and the clock signal line 60 on the motherboard. The figure does not illustrate a connection between an individual lead wire 63 and each signal line.

The internal reference potential VREFint of the semiconductor integrated circuit 59 mounted on the motherboard 58 can be adjusted according to the characteristics of the semiconductor integrated circuit. The use of this embodiment can change the VREF value corresponding to respective semiconductor integrated circuits and provide a semiconductor apparatus system which minimizes the setup and hold times for each semiconductor integrated circuit. Further, it is possible to provide same or approximate voltage margins at the time of acquisition of H-level and L-level data by varying an internal reference potential and provide a semiconductor apparatus system which improves voltage margins at the data acquisition time for respective semiconductor integrated circuits.

According to the present invention, it is possible to provide same or approximate setup and hold times at the acquisition of H-level and L-level data by varying an internal reference potential and improve the setup and hold times for the semiconductor integrated circuit.

Further, it is possible to provide same or approximate voltage margins at the time of acquisition of H-level and L-level data by varying an internal reference potential and improve the voltage margin at the time of data acquisition for the semiconductor integrated circuit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor integrated circuit comprising:
a reference potential conversion circuit which is supplied with n−1 (n is 2 or larger natural number) external reference potentials (VREF1, VREF2, . . . , VREFn−1) and converts external reference potentials to generate n−1 internal reference potentials (VREFint1, VREFint2, . . . , VREFintn−1) differing from external reference potentials and having a relationship with regard to the n−1 external reference potentials, and
an input circuit which is supplied with said internal reference potential (VREFint1, VREFint2, . . . , VREFintn−1) as reference potentials, is supplied with n values of data signals expressed by potentials, and compares a data signal and a reference potential to output a determination result.

2. The semiconductor integrated circuit according to claim 1, wherein said relationship between said external reference potentials (VREF1, VREF2, . . . , VREFn−1) and said internal reference potentials (VREFint1, VREFint2, . . . , VREFintn−1) is expressed by VREFintn−1=VREFn−1+A (n is 2 or larger natural number and A is a rational number except 0).

3. The semiconductor integrated circuit according to claim 1, wherein said relationship between said external reference potentials (VREF1, VREF2, . . . , VREFn−1) and said internal reference potentials (VREFint1, VREFint2, . . . , VREFintn−1) is expressed by VREFintn−1=B×VREFn−1 (n is 2 or larger natural number and B is a rational number except 0).

4. The semiconductor integrated circuit according to claim 1, wherein said relationship between said external reference potentials (VREF1, VREF2, . . . , VREFn−1) and said internal reference potentials (VREFint1, VREFint2, . . . , VREFintn−1) is expressed by VREFintn−1=C×VREFn−1+D (n is 2 or larger natural number and, C and D are rational numbers except 0).

5. The semiconductor integrated circuit according to claim 1, further comprising a storage circuit for holding data of a plurality of bits, and wherein
said relationship between said external reference potentials (VREF1, VREFint2, . . . , VREFn−1) and said internal reference potentials (VREFint1, VREFint2, . . . , VREFintn−1) is changed based on data of a plurality of bits stored in said storage circuit.

6. The semiconductor integrated circuit according to claim 5, wherein
said storage circuit for holding data of a plurality of bits is a one-time programmable storage circuit, and
said relationship between said external reference potentials (VREF1, VREFint2, . . . , VREFn−1) and said internal reference potentials (VREFint1, VREFint2, . VREFintn−1) is changed based on data of a plurality of bits stored in said storage circuit.

7. The semiconductor integrated circuit according to claim 6, wherein
said storage circuit includes a laser beam blown type fuse for specifying data of a plurality of bits to be held depending on whether a laser beam disconnects the fuse, and wherein
said relationship between said external reference potentials (VREF1, VREFint2, . . . , VREFn−1) and said internal reference potentials (VREFint1, VREFint2, . . . , VREFintn−1) is changed based on data of a plurality of bits stored in said laser beam blown type fuse.

8. The semiconductor integrated circuit according to claim 6, wherein
said storage circuit includes an electric current blown type fuse for specifying data of a plurality of bits to be held depending on whether an electric current disconnects the fuse, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said electric current blown type fuse.

9. The semiconductor integrated circuit according to claim 6, wherein
said storage circuit includes a dielectric film breakdown type fuse for specifying data of a plurality of bits to be held depending on whether a voltage breakdowns a dielectric film of the dielectric film breakdown type fuse, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said dielectric film breakdown type fuse.

10. The semiconductor integrated circuit according to claim 5, wherein
said storage circuit for holding data of a plurality of bits is a reprogrammable storage circuit, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said storage circuit.

11. The semiconductor integrated circuit according to claim 10, wherein
said storage circuit includes a semiconductor memory circuit for specifying data of a plurality of bits to be held, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said semiconductor memory circuit.

12. The semiconductor integrated circuit according to claim 11, wherein
said storage circuit includes a register for specifying data of a plurality of bits to be held, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said register.

13. The semiconductor integrated circuit according to claim 1, further comprising a first storage circuit for holding data of a plurality of bits, and a second storage circuit for holding data of a plurality of bits, and wherein
said relationship between said external reference potentials (VREF1, VREFint2, . . . , VREFn−1) and said internal reference potentials (VREFint1, VREFint2, . . . , VREFintn−1) is changed based on data of a plurality of bits stored in said first storage circuit or said second storage circuit.

14. The semiconductor integrated circuit according to claim 13, further comprising a selection circuit for selecting said first storage circuit or said second storage circuit, and wherein
said relationship between said external reference potentials (VREF1, VREFint2, . . . , VREFn−1) and said internal reference potentials (VREFint1, VREFint2, . . . , VREFintn−1) is changed based on data of a plurality of bits stored in said first storage circuit or said second storage circuit selected by said selection circuit.

15. The semiconductor integrated circuit according to claim 1, further comprising a selection circuit for selecting said first storage circuit or said second storage circuit, and wherein
said relationship between said external reference potentials (VREF1, VREF2, ., VREFn−1) and said internal reference potentials (VREFint1, VREFint2, . . . , VREFintn−1) is changed based on data of a plurality of bits stored in said first storage circuit or said second storage circuit selected by said selection circuit.

16. The semiconductor integrated circuit according to claim 5, wherein said input circuit compares an input data signal with the reference potential having n−1 values at the timing of a clock signal's leading and trailing edge or either edge and outputs a comparison result.

17. The semiconductor integrated circuit according to claim 13, wherein said input circuit compares an input data signal with the reference potential having n−1 values at the timing of a clock signal's leading and trailing edge or either edge and outputs a comparison result.

18. The semiconductor integrated circuit according to claim 14, wherein said input circuit compares an input data signal with the reference potential having n−1 values at the timing of a clock signal's leading and trailing edge or either edge and outputs a comparison result.

19. A semiconductor apparatus system, comprising:
a motherboard including an input/output terminal section and a data signal line and an external reference signal line connected to this input/output terminal section, and
a plurality of semiconductor integrated circuits which is mounted on said motherboard and includes a reference potential conversion circuit connected to said external reference signal line, supplied with n−1 (n is 2 or larger natural number) external reference potentials (VREF1, VREFint2, . . . , VREFn−1), and generating other potentials (VREFint1, VREFint2, . . . , VREFintn−1) differing from said external reference potentials and further includes an input circuit supplied with output potentials (VREFint1, VREFint2, . . . , VREFintn−1) from said reference potential conversion circuit as reference potentials, supplied with a data signal from said data signal line, comparing the input data signal with reference potentials having n−1 values for determination, and generating a determination result.

20. The semiconductor apparatus system according to claim 19, wherein
said semiconductor integrated circuit further comprises a storage circuit for holding data of a plurality of bits, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said storage circuit.

21. The semiconductor apparatus system according to claim 19, wherein
said semiconductor integrated circuit further comprises a first storage circuit for holding data of a plurality of bits, and a second storage circuit for holding data of a plurality of bits, and
said relationship between said external reference potentials (VREF1, VREFint2, . . . , VREFn−1) and said internal reference potentals (VREFint1, VREFint2, . . . , VREFintn−1) is changed based on data of a plurality of bits stored in said first storage circuit or said second storage circuit.

22. The semiconductor integrated circuit according to claim 19, wherein said semiconductor integrated circuit further comprises a selection circuit for selecting said first storage circuit or said second storage circuit, and
said relationship between said external reference potentials (VREF1, VREFint2, . . . , VREFn−1) and said internal reference potentials (VREFint1, VREFint2, . . . , VREFintn−1) is changed based on data of a plurality of bits stored in said first storage circuit or said second storage circuit selected by said selection circuit.
